(19) United States
(12) Patent Application Publication
(10) Pub. No.: US 2018/0311797 A1
(43) Pub. Date: Nov. 1, 2018

(54) RATCHET WRENCH

(71) Applicant: Cheng-Pu Yang, Taichung (TW)

(72) Inventor: Cheng-Pu Yang, Taichung (TW)

(21) Appl. No.: 15/499,895

(22) Filed: Apr. 28, 2017

(51) Int. Cl. B25B 13/46; B25B 23/00

(52) U.S. Cl. CPC B25B 13/463; B25B 23/0007

(57) ABSTRACT

A ratchet wrench includes a ratchet wheel and a pawl received in the head thereof. Two control members are movably connected to the top and bottom of the head and retain the pawl. Each control member includes a restriction hole and the protrusion on the pawl is movably received in the restriction hole. When the pawl is not engaged with the ratchet wheel, the protrusions move in the two respective restriction holes, and the ratchet wheel is still located in the through hole of the head. When the control members move outward, the protrusions and the pawl are moved outward, so that the pawl is separated from the ratchet wheel, and the top face and bottom face of the pawl are separated from the lip of the ratchet wheel and the ring. The ratchet wheel can be removed from the through hole.

### BACKGROUND OF THE INVENTION

### 1. Fields of the Invention

The present invention relates to a ratchet wrench, and more particularly, to a ratchet wrench having a simple structure and easily maintained.

### 2. Descriptions of Related Art

U.S. Pat. No. 8,042,433 discloses a ratchet wrench and includes a parts replacement structure that ensures effort-saved and smooth operation and prevents parts from getting lost. The wrench has a handle having an end forming a head portion that rotatably receives therein a driving collar. A lid plate is fixed to the head portion to retain a pawl member that engages and controls the rotation of the driving collar. The pawl member includes a pusher pad positioned on and movable along a top of the lid plate. A retention block is set at the side of the pawl member opposite to the driving collar to apply a biasing force to the pawl member through a push bar. In this arrangement, the push bar will not get lost when the pawl member disengages from and thus releases the driving collar for replacement.

However, there are too many parts involved in this structure and includes the pawl member, the linking bar, the pusher pad, the retention block, the push bar and the resilient biasing element. These parts require a lot of time to be assembled. The ratcheting teeth have to be drilled a passage for receiving the linking bar to extend, the passage weakens the ratcheting teeth.

The pusher pad and the linking bar are adhered together, and the adherent gradually fails so that the pusher pad may drop. If the pusher pad and the linking bar are connected by way of threading, the pusher pad and the linking bar have to be drilled a threaded hole which also increases manufacturing cost.

When the ratcheting teeth are moved backward, the pusher pad is moved backward with the ratcheting teeth, and the pusher pad vibrates when rotating the wrench.

When the driving collar is removed, the resilient biasing element pushes the ratcheting teeth, the pusher pad, the retention block and the push bar to be removed from the collar chamber. The ratcheting teeth, the pusher pad, the retention block and the push bar are difficult to be assembled correctly by the users.

The present invention intends to provide a ratchet wrench to eliminate the shortcomings mentioned above.

### SUMMARY OF THE INVENTION

The present invention relates to a ratchet wrench and comprises a ratchet wheel and a pawl received in the head thereof. Two control members are movably connected to the top and bottom of the head and retain the pawl. Each control member includes a restriction hole and the protrusion on the pawl is movably received in the restriction hole. When the pawl is not engaged with the ratchet wheel, the protrusions move in the two respective restriction holes, and the ratchet wheel is still located in the through hole of the head. When the control members move outward, the protrusions and the pawl are moved outward, so that the pawl is separated from the ratchet wheel, and the top face and bottom face of the pawl are separated from the lip of the ratchet wheel and ring. The ratchet wheel can be removed from the through hole.

The present invention will become more apparent from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view of the ratchet wrench of the present invention;

FIG. 2 is a top view of the head of the ratchet wrench of the present invention;

FIGS. 3 and 4 show the two control members of the ratchet wrench of the present invention;

FIG. 5 is a perspective view to show the ratchet wrench of the present invention, wherein the control members are not installed;

FIG. 6 is a top view of the of the ratchet wrench of the present invention disclosed in FIG. 5;

FIG. 7 is a perspective view to show the ratchet wrench of the present invention;

FIG. 8 is a top view of the of the ratchet wrench of the present invention disclosed in FIG. 7;

FIG. 9 is a top view of the head of the ratchet wrench of the present invention;

FIG. 10 is a cross sectional view, taken along line 10-10 in FIG. 8;

FIG. 11 shows that the control member is shifted;

FIG. 12 shows the movement of the pawl and the resilient member when the control member is shifted;

FIG. 13 shows that the ratchet wheel and the C-shaped clip are removed from the through hole of the head;

FIG. 14 shows the second embodiment of the ratchet wrench of the present invention;

FIG. 15 is an exploded view of the third embodiment of the ratchet wrench of the present invention;

FIG. 16 is a top view of the head of the third embodiment of the ratchet wrench of the present invention;

FIG. 17 shows the pawl of the third embodiment of the ratchet wrench of the present invention;

FIG. 18 shows the control member of the third embodiment of the ratchet wrench of the present invention;

FIG. 19 is a perspective view of the third embodiment of the ratchet wrench of the present invention;

FIG. 20 is a top view of the third embodiment of the ratchet wrench of the present invention;

FIG. 21 is a top view to show the third embodiment of the ratchet wrench of the present invention;

FIG. 22 is a cross sectional view, taken along line 22-22 in FIG. 20;

FIG. 23 is a side view of the third embodiment of the ratchet wrench of the present invention, and

FIG. 24 is a cross sectional view, taken along line 24-24 in FIG. 23.

### DETAILED DESCRIPTION OF THE PREFERRED EMBODIMENT

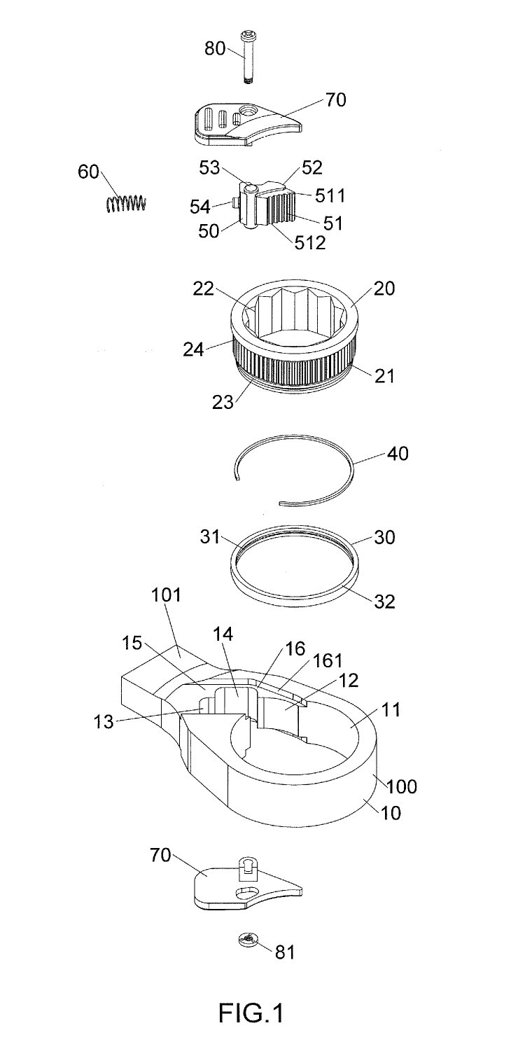

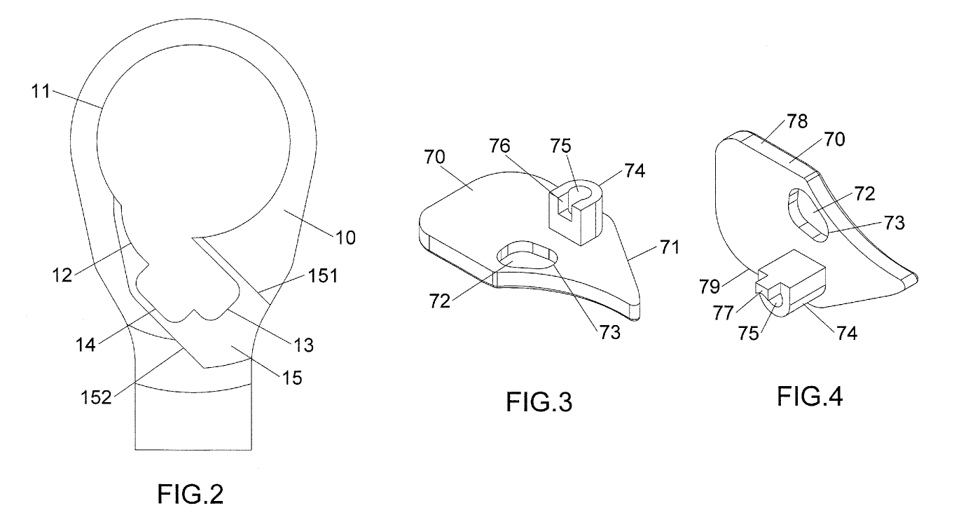

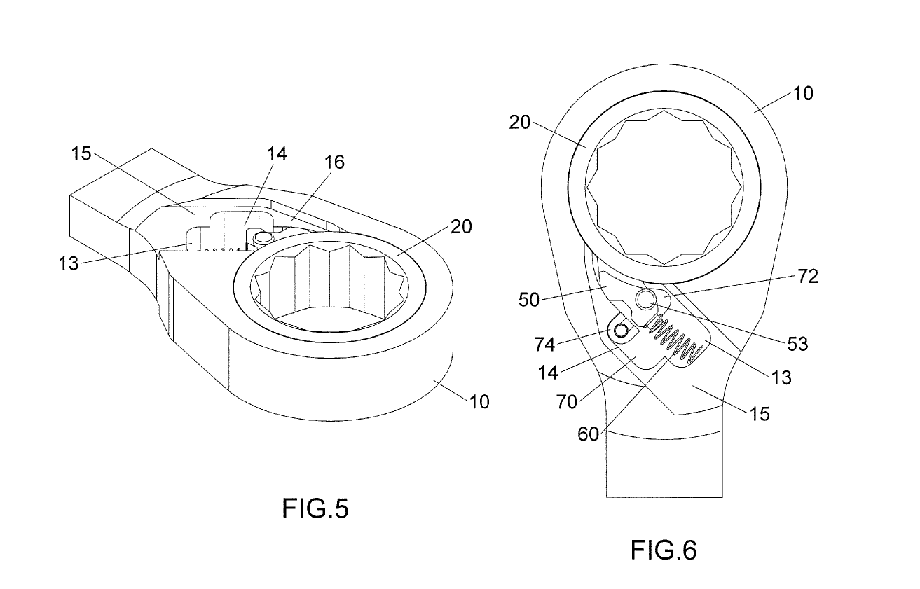

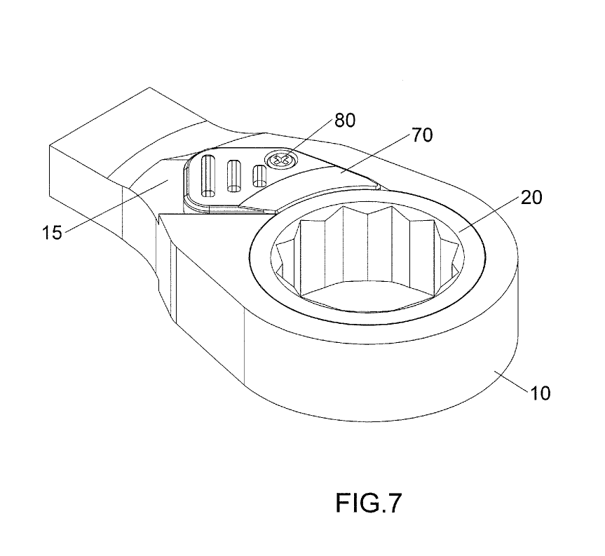

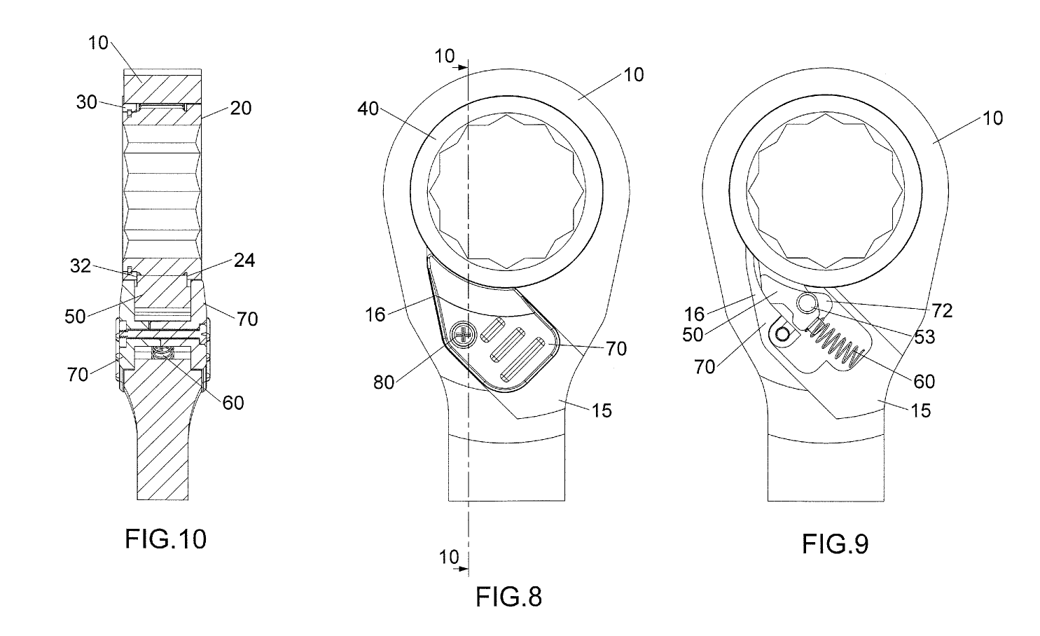

Referring to FIGS. 1 to 7, the ratchet wrench 10 of the present invention comprises a head 100 and a handle 101, and the head 100 has a through hole 11 defined through the top and the bottom thereof. A first recess 12 is defined in the inner periphery of the through hole 11, a second recess 14 is defined in the inner periphery of the first recess 12, and a third recess 13 is defined in the inner periphery of the second recess 14. A guide recess 15 is defined in each of the top and the bottom of the head 100, wherein the two guide recesses 15 are located to communicate with a portion of each of the first, second and third recesses 12, 14, 13. Each of the guide recesses 15 includes two parallel facing guide faces 151, 152, and a stop wall 161 extends from one end of one of the guide faces 152 at an angle. The stop wall 161 reduces the width of the guide recess 15 toward the through hole 11.

A ratchet wheel 20 is rotatably received in the through hole 11 and has a toothed portion 21 defined in the outer periphery thereof. A polygonal mounting hole 22 is defined through the ratchet wheel 20. A lip 24 extends radially from the top of the ratchet wheel 20, and an annular groove 23 is defined in the outer periphery of the bottom end of the ratchet wheel 20. A ring 30 is connected to the annular groove 23 of the ratchet wheel 20. The ring 30 includes an engaging groove 31. The top surface 32 of the ring 30 is located to face the lip 24. A resilient C-shaped clip 40 is engaged between the annular groove 23 and the engaging groove 31 to retain the ratchet wheel 20 in the through hole 11.

A pawl 50 is movably received in the first and third recesses 12, 13, and the pawl 50 has an engaging portion 51 defined in the front end thereof. The engaging portion 51 is engaged with the toothed portion 21 of the ratchet wheel 20. The engaging portion 51 of the pawl 50 includes a top face 511 and a bottom face 512, wherein the top face 511 contacts the lip 24, and the bottom face 512 contacts the ring 30. The ratchet wheel 20 is retained by the pawl 50. A curved face 52 is formed on one end of the rear end of the pawl 50, and contacts the inner periphery of the first recess 12. A cylindrical connection portion 54 formed on the other end of the rear end of the pawl 50. Two protrusions 53 respectively extend from the top and the bottom of the pawl 50. A resilient member 60 has one end connected to the connection portion 54, and the other end of the resilient member 60 is biased in third recess 13 to engage the engaging portion 51 with the toothed portion 21.

Two control members 70 are respectively and linearly movably received in the second recesses 14 and the two guide recesses 15, and contact two respective inner bottoms 16 of the guide recesses 15. Each control member 70 has a curved contact end 71 which contacts the stop wall 161 so that the two control members 70 are not separated from the two guide recesses 15. The stop wall 161 and the contact end 71 are complementary in shape. A restriction hole 72 is defined in each control member 70 and the protrusion 53 movably extends through the restriction hole 72 corresponding thereto. The inner diameter of each of the restriction holes 72 is larger than the outer diameter of each of the protrusions 53. When the pawl 50 is not engaged with the ratchet wheel 20, the protrusions 30 move in the restriction holes 72, and the top face 511 and the bottom face 512 are respectively in contact the lip 24 and the top surface 32 of the ring 30. so that the ratchet wheel 20 is still in the through hole 11.

Each restriction hole 72 has an inside 73 to contact the protrusion 53 to restrict the pawl 50 from being disengaged from the first recess 12. When each of the control members 70 moves outward the guide recesses 15, the inside 73 pushes the protrusion 53 and the pawl 50 to move outward to disengage the engaging portion 51 from the toothed portion 21. The top face 511 and the bottom face 512 are respectively separated from the lip 24 and the ring 30, so that the ratchet wheel 20 is able to be removed from the through hole 11. Each of the two control members 70 has a tubular portion 74 extending from a facing side 78/79 thereof which is in contact with the guide recess 151/152 corresponding thereto. Each tubular portion 74 has a passage 75 defined therein. One of the two tubular portions 74 has a tongue 77, and the other one of the two tubular portions 74 has a notch 76 in which the tongue 77 is inserted. A fastening member 80 extends through the two respective passages 75 and is connected with a clip 81 so that the two control members 70 are co-movable.

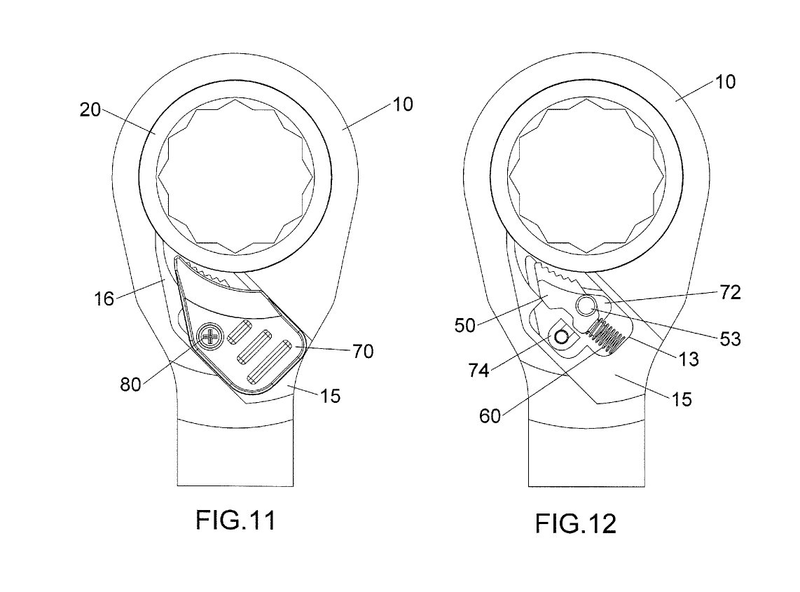

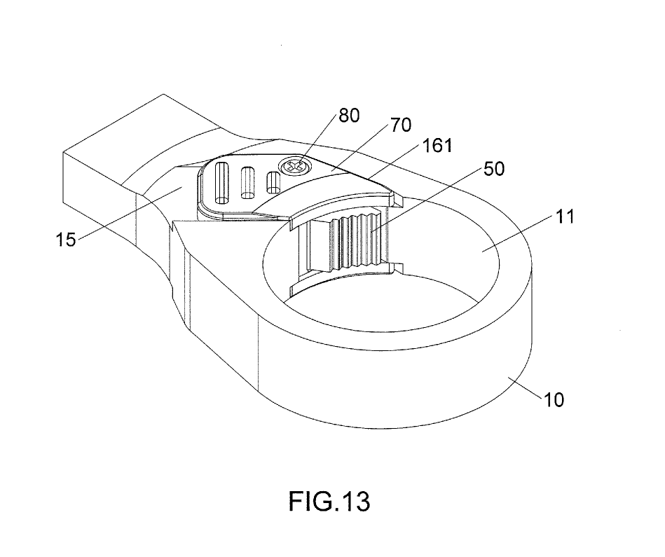

As shown in FIGS. 11 and 12, the control members 70 are movable in the second recesses 14 and the guide recesses 15. The protrusions 53 extend through the restriction hole 72. When the two control members 70 are shifted, the two control members 70 move the pawl 50 to move in the first recesses 12 and the third recesses 13, and the pawl 50 compresses the resilient member 60, and the engaging portion 51 is separated from the toothed portion 21. The top face 511 and the bottom face 512 are respectively separated from the lip 24 and the top surface 32 of the ring 30, so that the ratchet wheel 20, the ring 30 and the C-shaped clip 40 are able to be removed from the through hole 11 as shown in FIG. 13.

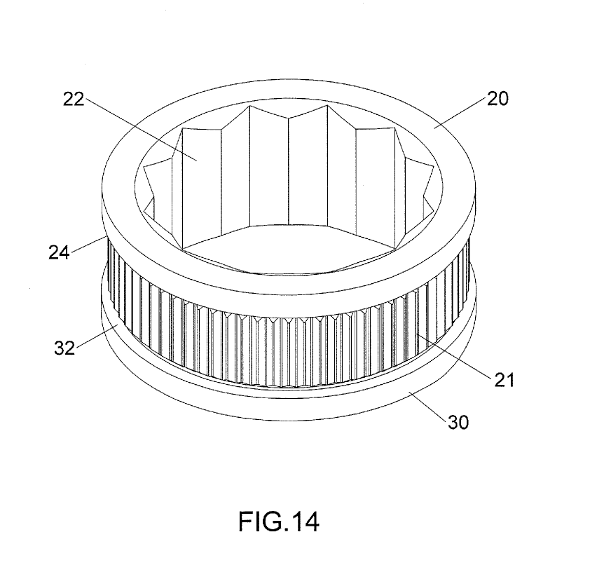

As shown in FIG. 14, the ratchet wheel 20 and the ring 30 are integrally formed as a one piece.

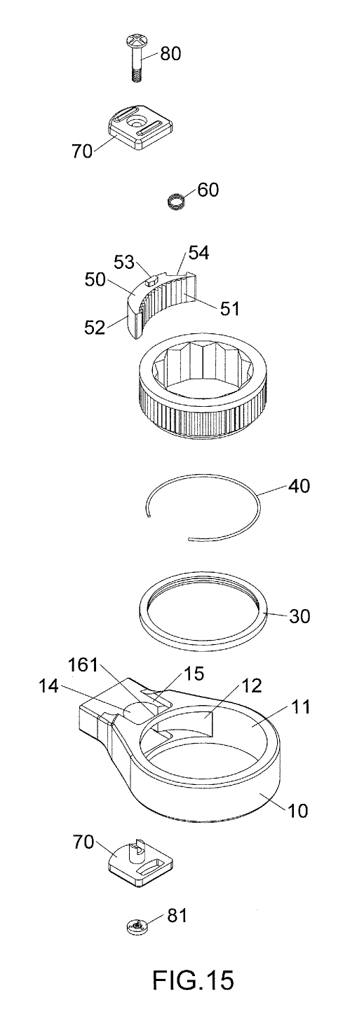

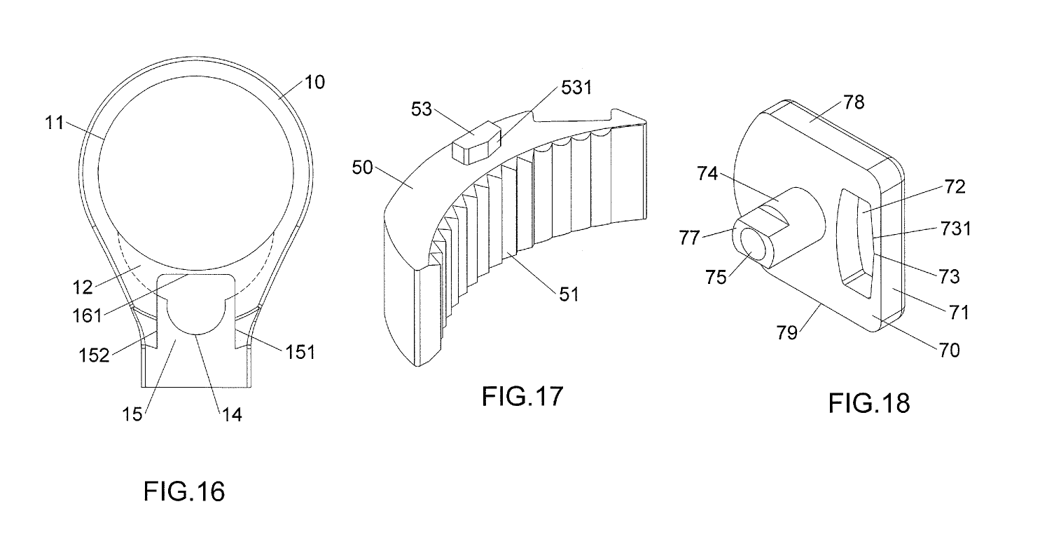

As shown in FIGS. 15 to 18, the first and third recesses 12, 13 have an identical shape and are symmetrical relative to the second recess 14. The diameter of the first recess 12 is smaller than the diameter of the through hole 11. The center of the first recess 12 is located within the through hole 11. The second recess 14 is a curved recess, and the center of the second recess 14 is not located in the first recess 12. The diameter of the second recess 14 is smaller than the diameter of the first recess 12. The protrusions 53 of the pawl 50 is a polygonal protrusion and includes a flat contact face 531. The connection portion 54 is a recess, so that the resilient member 60 is biased between the first recess 12 and the connection portion 54. The inside 73 of each of the control members 70 has a flat match side 731 which is in contact with the contact face 531 of the pawl 50.

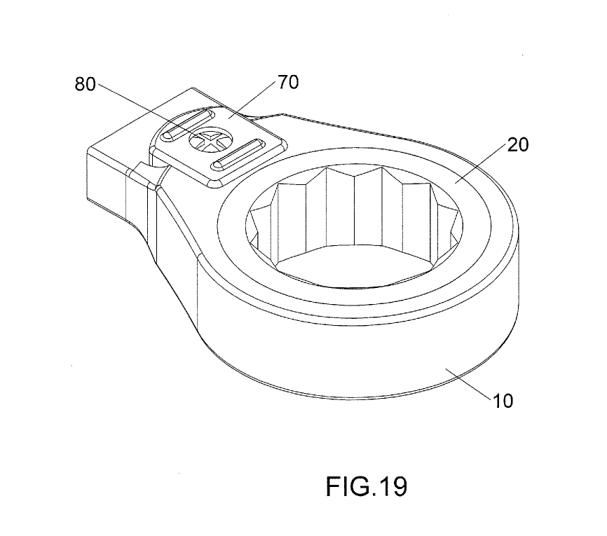

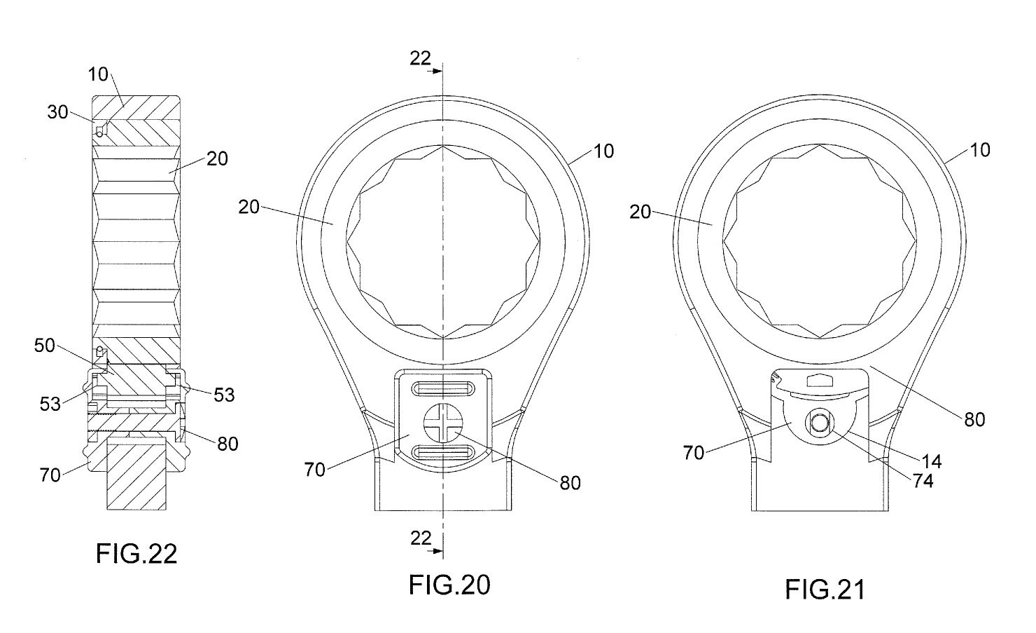

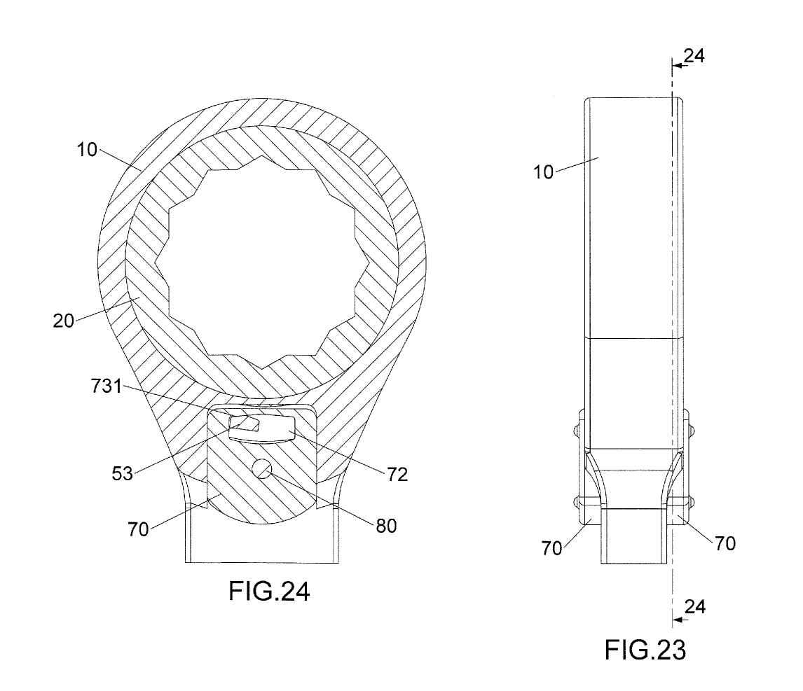

As shown in FIGS. 19 to 24, the pawl 50 is located in the first recess 12 and the control members 70 are received in the guide recesses 15. The polygonal protrusions 53 extend through the restriction holes 72. The contact faces 531 are in contact with the match sides 731. When the two control members 70 are shifted and move the pawl 50, the protrusions 53 do not rotate in the restriction holes 72. That is to say, when the ratchet wheel 20, the ring 30 and the C-shaped clip 40 are removed from the head 100, the pawl 50 does not rotate in the first recess 12.

The lip 24 and the ratchet wheel 20 can be two individual parts as shown in FIG. 1. The ring 30 and the lip 24 can be made of plastic or steel, and have different colors.

In another embodiment, the ring 30 and the ratchet wheel 20 are threadedly connected to each other or force-fitted to each other.

In yet another embodiment, the ring 30 is force-fitted to the through hole 11, and the clip 40 is a ring-shaped clip, so that when the ratchet wheel 20 is removed from the head 100, the ring 30 and the clip 40 are not separated from the head 100. The advantages of the present invention are that: 1) the pawl 50 does not have a recess so as to have better strength; 2) When the pawl 50 is disengaged from the ratchet wheel 20, because the protrusions 53 are located in the restriction holes 72, the control members 70 do not shift; 3) The contact end 71 of each control member 70 is stopped by the stop wall 161 so as to restrict the control member 70 from being disengaged from the guide recess 15, and the pawl 50 is not disengaged from the first recess 12 by the inside 73; 4) When the pawl 50 is not engaged with the ratchet wheel 20, the protrusions 53 move in the restriction holes 72, and the top face 511 and the bottom face 512 are respectively in contact the lip 24 and the top surface 32 of the ring 30, so that the ratchet wheel 20 is still in the through hole 11; 5) When each of the control members 70 moves outward the guide recesses 15, the inside 73 pushes the protrusion 53 and the pawl 50 to move outward to disengage the engaging portion 51 from the toothed portion 21. The ratchet wheel 20 is able to be removed from the through hole 11; 6) When the pawl 50 is disengaged from the ratchet wheel 20, the two control members 70 do not shift. When the control members 70 shift in the guide recesses 15, the pawl 50 is driven in the first recess 12; and 7) The ratchet wheel 20 can be removed from the top or bottom of the head from the through hole 11 when the two control members 70 and the pawl 50 are shifted.

While we have shown and described the embodiment in accordance with the present invention, it should be clear to those skilled in the art that further embodiments may be made without departing from the scope of the present invention.

What is claimed is:

1. A ratchet wrench comprising:
a head and a handle, the head having a through hole defined through a top and a bottom thereof, a first recess defined in an inner periphery of the through hole, a second recess defined in an inner periphery of the first recess, a third recess defined in an inner periphery of the second recess, a guide recess defined in each of the top and the bottom of the head, the two guide recesses located to communicate with a portion of each of the first, second and third recesses, each of the guide recesses including two facing guide faces, a stop wall extending from one end of one of the guide faces at an angle, the stop wall reducing a width of the guide recess toward the through hole;
a ratchet wheel rotatably received in the through hole and having a toothed portion defined in an outer periphery thereof, a lip extending radially from a top end of the ratchet wheel, a ring connected to the outer periphery of a bottom end of the ratchet wheel;
a pawl movably received in the first and third recesses, the pawl having an engaging portion defined in a front end thereof, the engaging portion engaged with the toothed portion of the ratchet wheel, engaging portion of the pawl including a top face and a bottom face, the top face contacting the lip, the bottom face contacting the ring, a curved face formed on a rear end of the pawl and contacting the inner periphery of the first recess, two protrusions respectively extending from a top and a bottom of the pawl;
a resilient member biased between the third recess and the pawl to engage the engaging portion with the toothed portion;
two control members respectively and movably received in the two guide recesses and contacting two respective inner bottoms of the guide recesses, each control member having a contact end which contacts the stop wall, a restriction hole defined in each control member and the protrusion movably extending through the restriction hole corresponding thereto, an inner diameter of each of the restriction holes being larger than an outer diameter of each of the protrusions, each restriction hole having an inside to contact the protrusion, when each of the control members moves outward in the second recesses and the guide recesses, the inside pushes the protrusion and the pawl to move outward to disengage the engaging portion from the toothed portion, the top face and the bottom face respectively separated from the lip and the ring, so that the ratchet wheel is removed from the through hole, each of the two control members having a tubular portion extending from a facing side thereof which is in contact with the guide recess corresponding thereto, each tubular portion having a passage, and
a fastening member extending through the two respective passages and connected with a clip so that the two control members are co-movable.

2. The ratchet wrench as claimed in claim 1, wherein the stop wall and the contact end are complementary in shape.

3. The ratchet wrench as claimed in claim 1, wherein the ratchet wheel includes a polygonal mounting hole defined therethrough.

4. The ratchet wrench as claimed in claim 1, wherein the ratchet wheel includes an annular groove, the ring includes an engaging groove, a C-shaped clip is engaged between the annular groove and the engaging groove.

5. The ratchet wrench as claimed in claim 1, wherein the pawl includes a cylindrical connection portion on the rear end thereof, the resilient member has one end thereof mounted to the connection portion.

6. The ratchet wrench as claimed in claim 1, wherein one of the two tubular portions has a tongue, the other one of the two tubular portions has a notch in which the tongue is inserted.

7. The ratchet wrench as claimed in claim 1, wherein the ratchet wheel and the ring are integrally formed as a one piece.

8. The ratchet wrench as claimed in claim 1, wherein the first and third recesses have an identical shape and are symmetrical relative to the second recess, a diameter of the first recess is smaller than a diameter of the through hole, a center of the first recess is located within the through hole, the second recess is a curved recess, a center of the second recess is not located in the first recess, a diameter of the second recess is smaller than the diameter of the first recess, the protrusions of the pawl is a polygonal protrusion and includes a flat contact face, the connection portion is a recess, the resilient member is biased between the first recess and the connection portion, the inside of each of the control members has a flat match side which is in contact with the contact face of the pawl.

9. The ratchet wrench as claimed in claim 1, wherein the lip and the ring are connected to the ratchet wheel by two clips.

10. The ratchet wrench as claimed in claim 1, wherein the ring and the ratchet wheel have different colors, the ring is made of plastic or steel.

11. The ratchet wrench as claimed in claim 1, wherein the ring and the ratchet wheel are threadedly connected to each other or force-fitted to each other.

12. The ratchet wrench as claimed in claim 1, wherein the ring is force-fitted with the through hole, when the ratchet wheel is removed from the through hole, the ring is not removed from the through hole.
